(19) United States
(12) Patent Application Publication
(10) Pub. No.: US 2009/0167196 A1
(43) Pub. Date: Jul. 2, 2009

(54) POWER SUPPLY FOR LIGHT EMITTING DIODE DEVICE

(75) Inventors: CHUN-WEI WANG, Chu-Nan (TW); HUNG-KUANG HSU, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/045,161

(22) Filed: Mar. 10, 2008

(30) Foreign Application Priority Data
Dec. 27, 2007 (CN) 200710203436.0

(51) Int. Cl. H05B 37/00; F03B 13/06; H02J 7/00

(52) U.S. Cl. 315/171; 290/54; 320/128

(57) ABSTRACT

A power supply (100) includes a generator (20) and a water circulatory channel. The generator includes an impeller (201) and an armature (203). The water circulatory channel contains water therein. The water flows along a predetermined direction in the water circulatory channel. The impeller of the generator is positioned to be at least partially submerged in and driven by the flowing water, and the impeller drives the armature to generate DC (205) for an LED lamp (30).

### BACKGROUND OF THE INVENTION

1. Field of the Invention

The present invention relates to a power supply, and more particularly to a power supply for a light emitting diode device.

2. Description of Related Art

Light emitting diodes (LEDs) have many advantages, such as high luminance, low power consumption, compatibility with integrated circuits, long-term reliability, and environmental friendliness so that LEDs have come to be widely used as backlight sources for liquid crystal displays (LCDs), light sources for vehicle lights, and luminance devices, as described in an article titled “Unique White LED Packaging Systems” cited in a publication of 2003 IEEE Electronic Components and Technology Conference authored by Atsushi Okuno.

In related art, LED devices are generally powered by commercial power. Input of the LED devices is direct current (DC), which is commutated from alternating current (AC) of the commercial power. However, in the process of commutation, much power is lost.

Accordingly, what is needed is an energy saving power supply for LED devices.

### SUMMARY OF THE INVENTION

A power supply comprises a generator and a water circulatory channel. The generator includes an impeller and an armature. The water circulatory channel contains water therein. The water flows along a predetermined direction in the water circulatory channel. The impeller of the generator is positioned to be at least partially submerged in and driven by the flowing water, and the impeller drives the armature to generate DC for an LED lamp.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a schematic view of a power supply in accordance with a preferred embodiment of the present invention;

FIG. 2 is a schematic view of an LED device using the power supply of FIG. 1 in accordance with an embodiment of the present invention; and

FIG. 3 is a schematic view of an LED device using the power supply of FIG. 1 in accordance with another embodiment of the present invention.

### DETAILED DESCRIPTION OF THE INVENTION

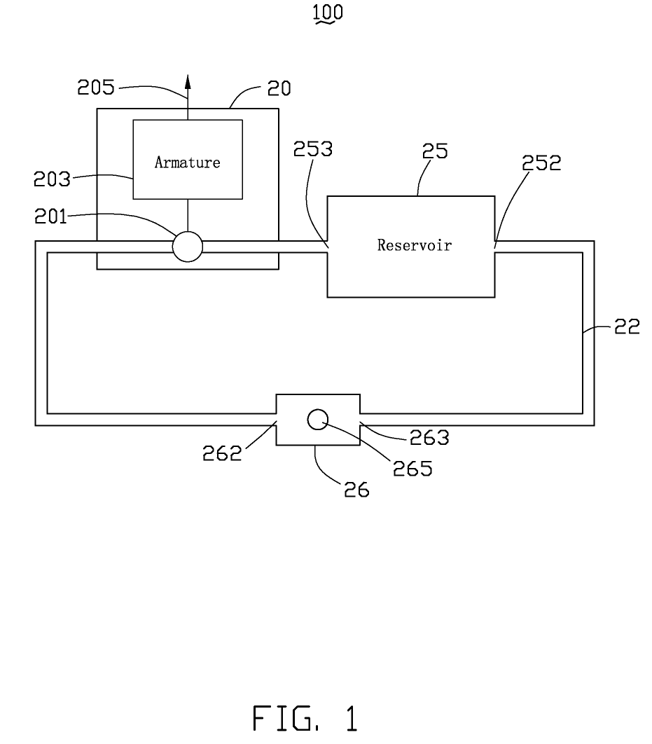

Referring to FIG. 1, a power supply 100 in accordance with a preferred embodiment of the present invention is shown. The power supply 100 is preferably used to provide a direct current (DC) 205 supply. The power supply 100 comprises a generator 20, a water channel 22, a reservoir 25, and a water pump 26. The channel 22, the reservoir 25, and the water pump 26 cooperatively form a water circulation system. The reservoir 25 contains water therein. The channel 22 communicates the reservoir 25 with the water pump 26. The water pump 26 is used to drive the water in the reservoir 25 to flow in a predetermined direction. Thus, the water in the reservoir 25 can flow through the generator 20, the reservoir 25, and the water pump 26 through the channel 22.

The generator 20 is for generating DC voltage, and generally comprises an impeller 201 and an armature 203. The impeller 201 is positioned to be at least partially submerged in and driven by the water as it flows in the channel 22. The armature 203 can generate the DC 205 when driven by the impeller 201. The armature 203 comprises a stator, a rotor having a coil loop, and a commutator. The rotor of the armature 203 can be driven to rotate by the impeller 201 through a gear (not shown). The stator is used to generate a magnetic field. The coil loop of the rotor rotates in the magnetic field of the stator, to thereby generate an alternating voltage, which is commutated to the DC 205 by the commutator.

The reservoir 25 is any suitable water container, and contains a supply of water therein. The reservoir 25 comprises an inlet 252 through which the water flows into the reservoir 25 and an outlet 253 through which the water flows out of the reservoir 25.

The water pump 26 can be arranged in the channel 22 or the reservoir 25. It is to be understood that the water pump 26 is advantageously arranged in the channel 22. The water pump 26 comprises an inlet 262, an outlet 263, and a motor 265. The motor 265 can be powered by commercial power and is used to drive the water pump 26, which draws water in through the inlet 262, and out through the outlet 263. Thus, the water can flow in the predetermined direction along the channel 22 driven by the water pump 26. The water pump 26 can, advantageously, also be configured to filter and oxygenate the water from the reservoir 25.

The generator 20 can be arranged at a position adjacent to the inlet 252 or the outlet 253 of the reservoir 25. It is to be understood that more than one generator 20 can be arranged in the power supply 100 for providing more electricity. In use, the motor 265 of the water pump 26 is started up and the water flows in the channel 22 through the generator 20, the reservoir 25, and the water pump 26 along the predetermined direction. When the water flows through the generator 20, the impeller 201 of the generator 20 is driven to rotate which in turn drives the armature 203 to generate the DC 205. Thus, the power supply 100 makes use of the water circulating through the channel 22 to provide the DC 205. Thus, energy from the circulating water is effectively used so that energy is saved over the usual method of using commercial power

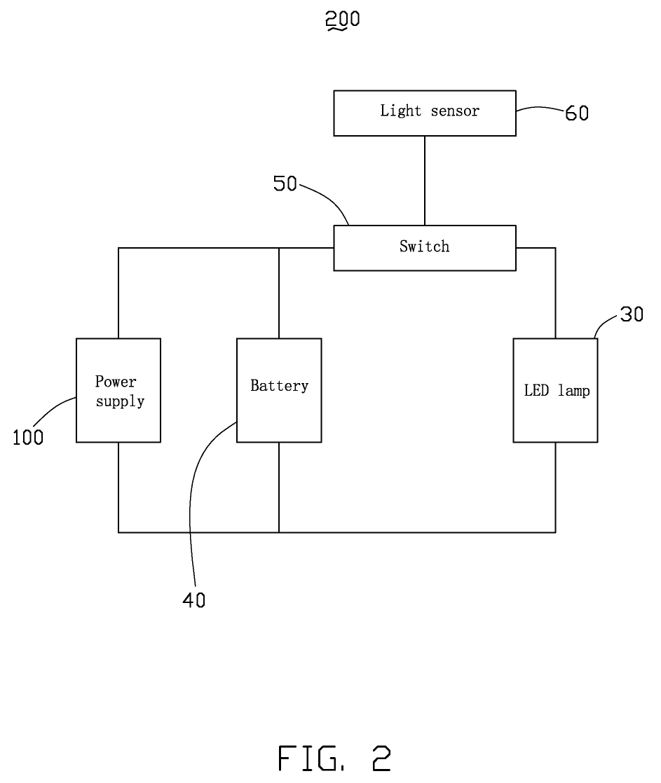

Referring to FIG. 2, an LED device 200 using the power supply 100 of FIG. 1 in accordance with an embodiment of the present invention is shown. The LED device 200 further comprises an LED lamp 30, a battery 40, a switch 50, and a light sensor 60, which form a circuit with the power supply 100. The battery 40 connects in parallel to the LED lamp 30. An end of the battery 40 connects with an end of the LED lamp 30 through the switch 50. Another end of the LED lamp 30 connects with another end of the battery 40. The generator 20 is electrically connected to the battery 40 and is used to charge the battery 40, which provides DC for the LED lamp 30. The switch 50 is used to control the LED lamp 30 to be turned on/off. The light sensor 60 is used to detect brightness of ambient light. For example, if the brightness of the ambient light detected by the light sensor 60 is not bright enough, the light sensor 60 sends a signal to the switch 50 to control the switch 50 to electrically connect the battery 40 to the LED lamp 30 so that the LED lamp 30 turns on and provides additional illumination. If the brightness is bright enough, the light sensor 60 sends a signal to the switch 50 to control the switch 50 to disconnect the battery 40 from the LED lamp 30 so that the LED lamp 30 is turned off.

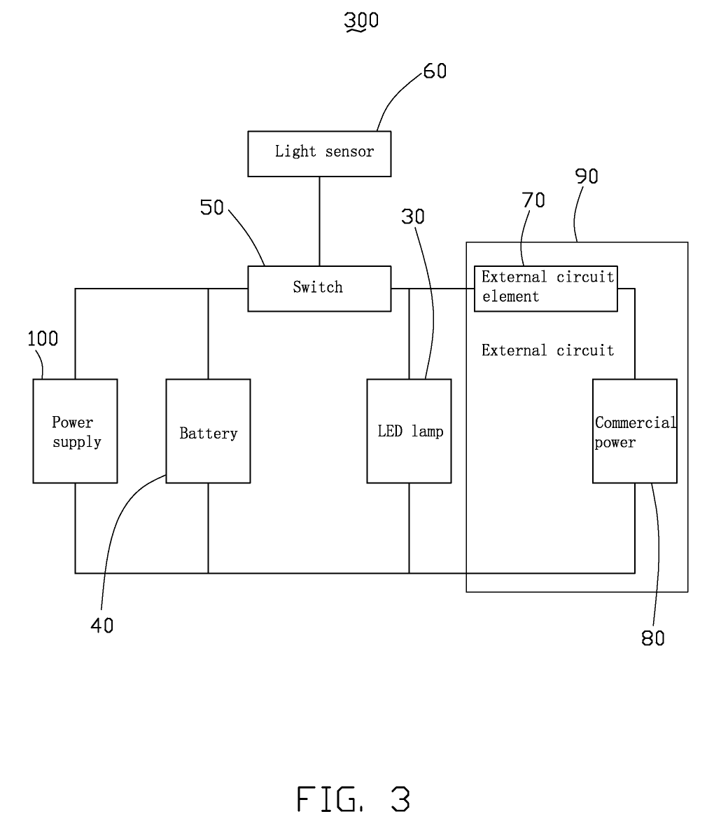

Referring to FIG. 3, an LED device 300 using the power supply 100 of FIG. 1 in accordance with another embodiment of the present invention is shown. The LED device 300 has a similar configuration to the LED device 200. The difference between the LED device 200 and the LED device 300 is that the LED device 300 further comprises a backup power source 90 comprising a backup power source element 70 and commercial power 80. The backup power source element 70 communicates the LED lamp 30 with the commercial power 80 and commutates AC of the commercial power 80 into DC. In this embodiment, the backup power source element 70 is a switch. The LED device 300 has a detector (not shown) for detecting whether the battery 40 has enough power or not. If the battery 40 does not have enough power, the switch 70 is turned on so that the backup power source 90 can be used to provide DC for the LED lamp 30.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the power supply 100 can be further arranged in other water circulation systems, such as might occur naturally, like in a stream for example, in which case any or all of the water channel 22, the reservoir 25, and the water pump 26 may be modified or omitted.

What is claimed is:

1. A power supply comprising:
a generator comprising an impeller and an armature; and
a water circulatory channel containing circulatory water flowing therein,
wherein the impeller of the generator is disposed in the circulatory water.

2. The power supply as described in claim 1, further comprising a reservoir for containing the water and a water pump for driving the water to flow in the channel.

3. The power supply as described in claim 2, wherein the reservoir comprises an inlet and an outlet, the generator being positioned adjacent to the inlet or the outlet of the reservoir.

4. The power supply as described in claim 3, wherein the reservoir is a swimming pool.

5. An LED device comprising:
an LED lamp;
a direct current generator; and
a water circulatory channel containing circulatory water flowing therein, the generator is disposed in the water for generating and supplying direct current to the LED lamp.

6. The LED device as described in claim 5, further comprising a rechargeable battery electrically connected with the generator.

7. The power supply as described in claim 6, further comprising a switch for controlling switching the LED lamp on/off and a light sensor for detecting brightness of ambient light, the rechargeable battery being connected to the LED lamp through the switch.

8. The power supply as described in claim 7, further comprising a mains power supply for powering the LED lamp, and a converter for converting alternating current of the mains power supply into the direct current.

9. An LED device comprising:
a circulatory channel containing circulatory water flowing therein
an LED lamp; and
a direct current generator including an impeller and an armature, the impeller being disposed in the circulatory water for being driven by the flowing water, the a direct current generator being configured for generating and supplying direct current to the LED lamp.

10. The power supply as described in claim 9, further comprising a rechargeable battery for powering the LED lamp, the direct current generator being electrically connected to and configured for recharging the rechargeable battery.
